(19) United States
(12) Patent Application Publication
(10) Pub. No.: US 2024/0410552 A1
(43) Pub. Date: Dec. 12, 2024

(54) LIGHT FIXTURE CONNECTION SYSTEM AND OPTIC HOLDER

(71) Applicant: HLI SOLUTIONS, INC., GREENVILLE, SC (US)

(72) Inventors: Qianshan LI, Glendora, CA (US); Kevin LU, Fountain Valley, CA (US); Syed RAZA, Rancho Palos Verdes, CA (US); Dean DAL PONTE, Glendale, CA (US)

(21) Appl. No.: 18/809,790

(22) Filed: Aug. 20, 2024

Related U.S. Application Data
(63) Continuation of application No. 18/354,209, filed on Jul. 18, 2023, now Pat. No. 12,092,295.
Application No. 18/354,209 is a division of application No. 17/321,339, filed on May 14, 2021, now Pat. No. 11,746,990.
(60) Provisional application No. 63/025,906, filed on May 15, 2020.

(51) Int. Cl. F21V 15/01; F21V 19/00; F21V 23/06; F21Y 103/10; F21Y 115/10

(52) U.S. Cl. CPC F21V 15/01; F21V 19/0035; F21V 23/06; F21Y 2103/10; F21Y 2115/10

(57) ABSTRACT

A light fixture is provided that includes a housing and a light assembly having a plurality of light emitting diodes (LEDs) supported on an LED board that is supported in the housing. The light fixture also includes a plurality of optics, wherein each optic is positioned adjacent an associated LED, and a holder body supported within the housing. The holder body includes a plurality of recesses that support each optic. In some embodiments, the housing of the light fixture may include a main portion and a support portion, and may further include a support arm operably connected to the support portion and configured for supporting the light fixture on a surface.

### REFERENCE TO RELATED APPLICATIONS

The present application is a continuation application of, and claims the benefit of, U.S. patent application Ser. No. 18/354,209, filed on Jul. 18, 2023, which is a divisional patent application of and claims the benefit of U.S. patent application Ser. No. 17/321,339 filed on May 14, 2021, which claims the benefit of U.S. Provisional Patent Application No. 63/025,906, filed May 15, 2020, and the entire contents of which are hereby incorporated by reference.

### FIELD OF THE INVENTION

The present disclosure relates to light fixtures, and particularly to connection for coupling multiple fixtures to one another.

### SUMMARY

In an aspect, a light fixture is provided that includes a housing, a light assembly, a plurality of optics and a holder body. In some embodiments, the light assembly includes a plurality of light emitting diodes (LEDs) supported on an LED board which is supported in the housing, and the plurality of optics has each optic positioned adjacent an associated LED of the LED board. In addition, the holder body is supported within the housing and includes a plurality of recesses wherein each recess may support an optic.

In some implementations, the housing includes a main portion and a support portion, and also includes a support arm operably connected to the support portion and configured to support the light fixture on a surface. The main portion may include an opening through which light is emitted from the plurality of LEDs.

In an aspect, the plurality of optics are total internal reflection (TIR) optics, and each TIR optic may include one end positioned adjacent an associated LED of the LED board and a second end through which light is output. In some embodiments, each recess of the holder body is shaped to be substantially similar to the shape of the outer surface of an optic, and may be of a substantially frustoconical shape. In addition, in some embodiments the holder body includes a retention feature adjacent each recess, and the retention feature may be a snap fit feature which secures an associated optic. In some embodiments, each optic has a complementary feature for engaging the retention feature, and each complementary feature may provide a snap fit feature between each recess and an associated optic.

In another aspect, a system of interconnected light fixtures is provided. In some embodiments, the system of interconnected light fixtures includes a first light fixture, a second light fixture, a bracket, an electrical cord, and a cover. In some embodiments, the first light fixture includes an elongated first housing and a first light emitting element, the first housing including a first end, a second end, and a first electrical connector. In addition, the second light fixture includes an elongated second housing and a second light emitting element, the second housing including a first end, a second end, and a second electrical connector. The bracket is configured for coupling to the first light fixture by a first fastener, wherein the bracket includes a first portion configured to be coupled to the first light fixture and a second portion configured to be coupled to the first light fixture. Also, the electrical cord provides electrical communication between the first light fixture and the second light fixture, and it includes a third electrical connector removably coupled to the first electrical connector, and a fourth electrical connector removably coupled to the second electrical connector. The cover is also removably coupled to the first light fixture via the bracket by a second fastener and removably coupled to the second light fixture, the cover extending over the electrical cord, the cover including a first end adjacent the first light fixture, a second end adjacent the second light fixture, and a cover surface extending between the first end and the second end, a portion of the cover surface adjacent the first end having a profile that corresponds to a profile of a surface of the first light fixture, and a portion of the cover surface adjacent the second end having a profile that corresponds to a profile of a surface of the second light fixture, providing a continuous surface between the first light fixture and the second light fixture.

In some implementations of the system of interconnected light fixtures, the bracket is a first bracket, and the system further includes a second bracket coupled to the second light fixture, and wherein the cover is removably coupled to the second bracket via a third fastener. In some embodiments, the first portion of the bracket may include a first flange oriented parallel to a first portion of the cover, wherein the first flange comprises a hole for receiving a fastener extending through the first portion of the cover. In addition, the second portion of the bracket may include a second flange oriented parallel to a second portion of the cover, wherein the second flange comprises a hole for receiving a fastener extending through the second portion of the cover.

In some embodiments of the system of interconnected light fixtures, the first housing may include a first portion and a second portion, wherein the first portion includes an opening through which light from the first light emitting element passes, and the second portion is positioned on a side of the first portion opposite the opening. The second portion may have a length less than a length of the first portion of the housing, and the first electrical connector may be positioned on the second portion of the housing. In addition, the first end of the cover may be positioned adjacent a surface of the second portion. In another implementation, an end of the second portion proximate the cover may be configured to be selectively coupled to an end plate.

Other aspects will become apparent by consideration of the detailed description and accompanying drawings.

### BRIEF DESCRIPTION OF THE DRAWINGS

FIG. 1 is a perspective view of a light fixture.

FIG. 2 is another perspective view of the light fixture of FIG. 1.

FIG. 3 is an exploded view of a portion of the light fixture of FIG. 1.

FIG. 4 is an enlarged perspective view of a portion of the light fixture of FIG. 1 with an end plate removed.

FIG. 5 is a partially exploded view of the light fixture of FIG. 1 coupled to another light fixture.

FIG. 6 is an enlarged view of a portion of the assembly of FIG. 5.

FIG. 7 is a perspective view of a bracket.

FIG. 8 is a perspective view of a portion of the light fixture of FIG. 1 coupled to another light fixture.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

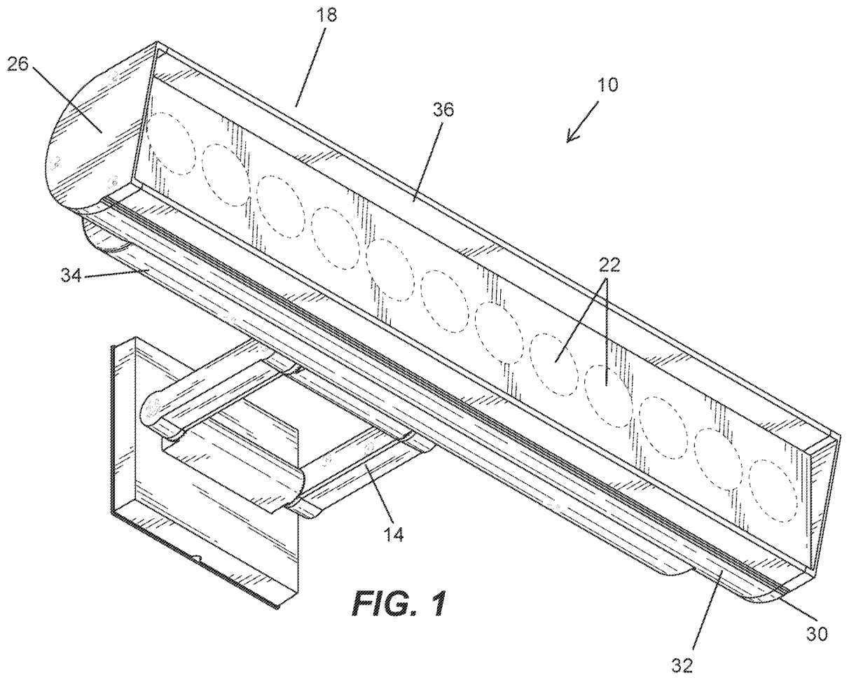

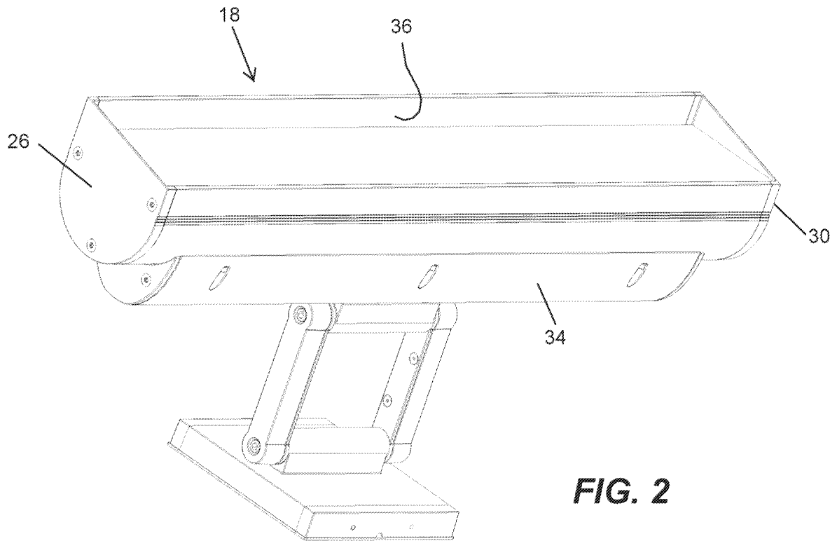

FIGS. 1 and 2 illustrate a light fixture 10 (e.g., a wall-mounted fixture) including a housing 18 supporting a plurality of light emitting elements 22 (e.g., LEDs—FIG. 1). The light fixture 10 is supported on a surface (e.g., a wall, not shown) by a support structure (e.g., a support arm 14). In the illustrated embodiment, the housing 18 is elongated and includes a first end 26 and an opposite second end 30. In addition, the housing 18 includes first portion or main portion 32 and a second portion or support portion 34. The main portion 32 includes an opening 36 through which light emitted by the light emitting elements 22 passes. The support portion 34 is positioned on a side of the main portion opposite the opening 36. In the illustrated embodiment, the support portion 34 has a shorter length than the main portion 32. Stated another way, the support portion 34 extends a portion of the length between the first end 26 and the second end 30. In the illustrated embodiment, a driver (not shown) is supported in a compartment of the housing 18.

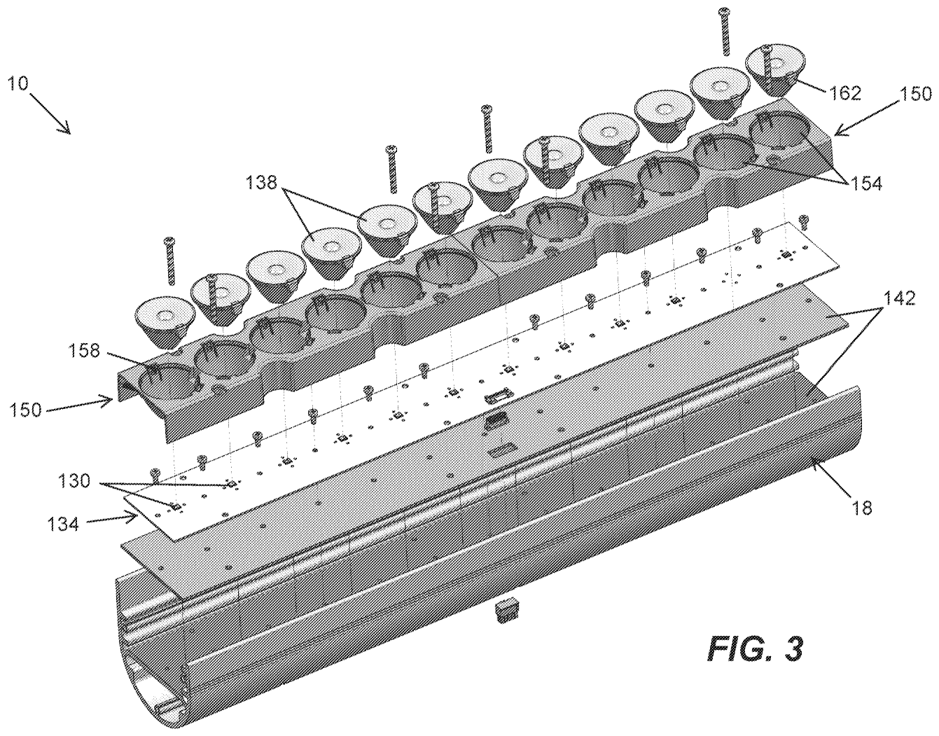

As shown in FIG. 3, in the illustrated embodiment, the light fixture 10 includes a light assembly including a plurality of light emitting diodes or LEDs 130 supported on a circuit board or LED board 134. In addition, an optic 138 (e.g., a TIR optic) is associated with each LED 130. In some embodiments, the optic 138 may be a total internal reflection (TIR) optic having one end positioned adjacent the associated LED 130, and another end through which light is output. The LED board 134 is supported in the housing 18, and is in electrical communication with a driver (not shown) via one or more electrical connectors. In the illustrated embodiment, the LED board 134 is coupled to one or more support members 142 positioned in the housing 18.

The optics 138 are supported in a holder body 150. The holder body 150 includes recesses 154, each of which receives one of the optics 138. In the illustrated embodiment, each recess 154 has a shape that is substantially similar to the shape of the outer surface of the optic 138 (for example, a frustoconical shape). In addition, the holder body 150 includes a retention feature 158 (e.g., a tab or detent) adjacent each recess 154, and each optic 138 includes a complementary feature 162 for engaging the retention feature 158 to provide a snap fit feature between each recess 154 and the associated optic 138. In the illustrated embodiment, the holder body 150 supports six optics 138, and the housing 18 supports two holder bodies 150; in other embodiments, the holder body may be configured to support fewer or more optics, and/or the housing may be configured to support fewer or more holder bodies. The holder body 150 is secured (e.g., by fasteners) to a support surface 142 in the housing 18. In contrast to conventional designs that include discrete or separate optic holders, the unitary holder body 150 facilitates easier assembly of optics into the holder body 150, and easier assembly of the optics into the housing 18. The orientation of each optic is secured to avoid the need to individually adjust or position each optic.

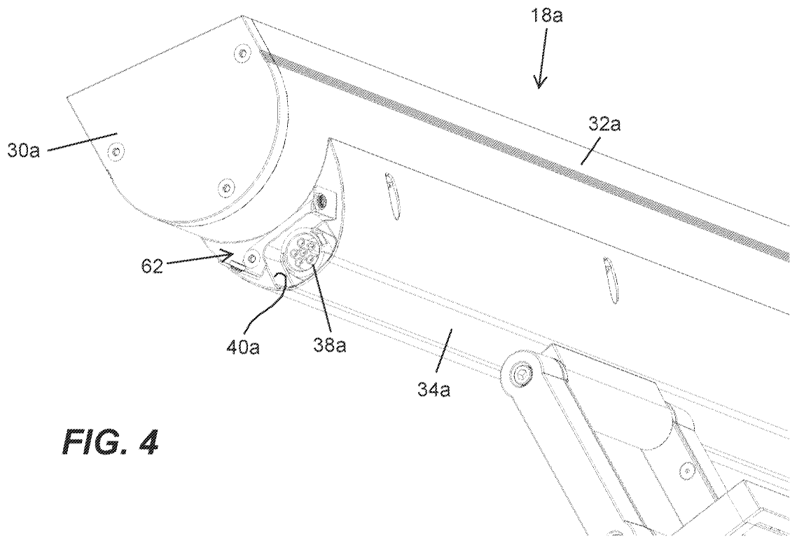

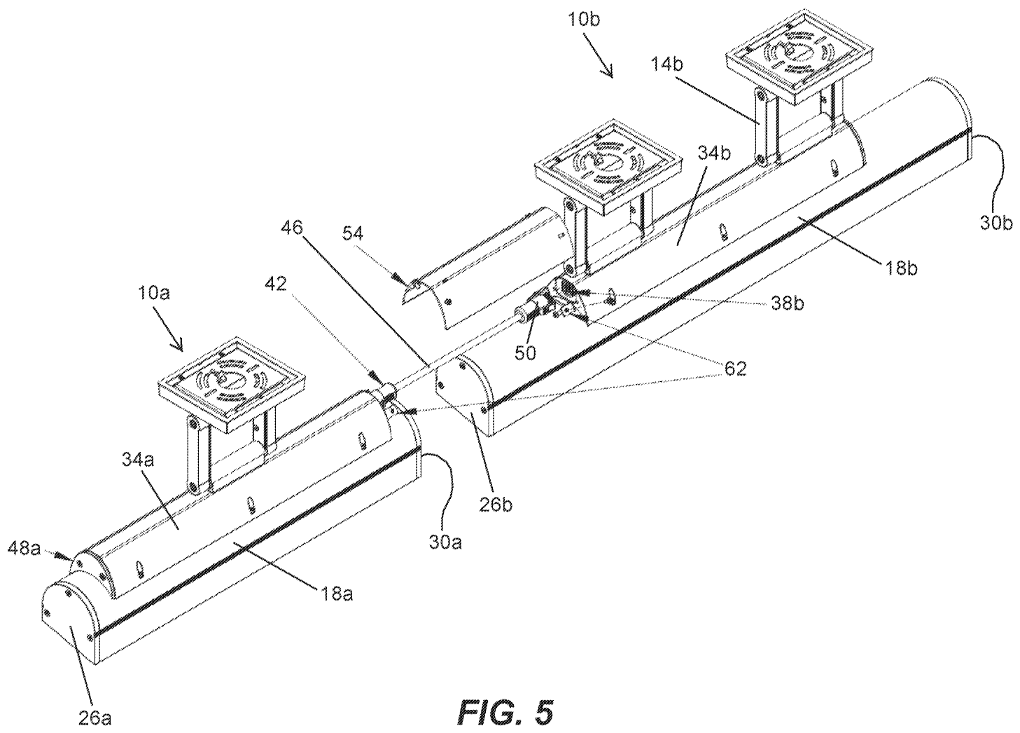

Referring now to FIGS. 4 and 5, the light fixture 10 (hereinafter referred to as a first light fixture 10a) may be connected to a second light fixture 10b. As described herein, features of the first light fixture 1Oa are identified with reference numbers having an “a” suffix, while features of the second light fixture 1Ob are identified with reference numbers having a “b” suffix.

As best shown in FIG. 4, in the illustrated embodiment, an electrical connector (e.g., a receptacle 38a) is positioned proximate the second end 30a of the housing 18a (for example, on an end surface of the support portion 34a). The receptacle 38a may be positioned in a recess 40a such that the receptacle 38a does not protrude from an end of the support portion 34a. When not in use, the receptacle 38a may be covered by an end plate or end cover 48a (FIG. 5). The receptacle 38a engages a connector 42 of an electrical cable 46 (FIG. 5). Similarly, a receptacle 38b is positioned proximate a first end 26b of a housing 18b of the second fixture 10b (e.g., on an end surface of support portion 34a), and the receptacle of the second fixture 10b engages another connector 50 of the cable 46.

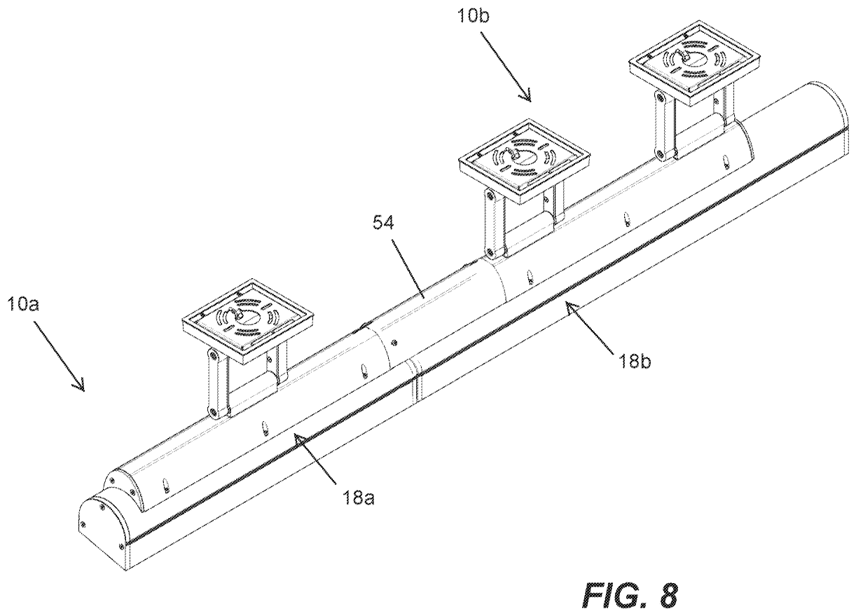

A cover 54 is removably coupled to the housings 18a, 18b to enclose the cable 46 and the connectors 42, 50 and protect them against the environment. In the illustrated embodiment, and as best shown in FIG. 8, the cover 54 has a similar shape to the surfaces of the housings 18a, 18b that are adjacent the receptacles 38a, 38b (that is, the surfaces of the support portions 34a, 34b), thereby providing a continuous appearance between the light fixtures 1Oa, 1Ob. Stated another way, the cover 54 has a first end positioned adjacent the first fixture 10a and a second end positioned adjacent the second fixture 10b. A portion of the outer surface of the cover 54 adjacent the first end of the cover has a profile that corresponds to (e.g., is substantially continuous with) a profile of a surface of the adjacent portion of the first light fixture 18a. Similarly, a portion of the outer surface of the cover 54 adjacent the second end of the cover has a profile that corresponds to (e.g., is substantially continuous with) a profile of a surface of the adjacent portion of the second light fixture 18b. As a result, the cover 54 provides a continuous profile between the first light fixture and the second light fixture.

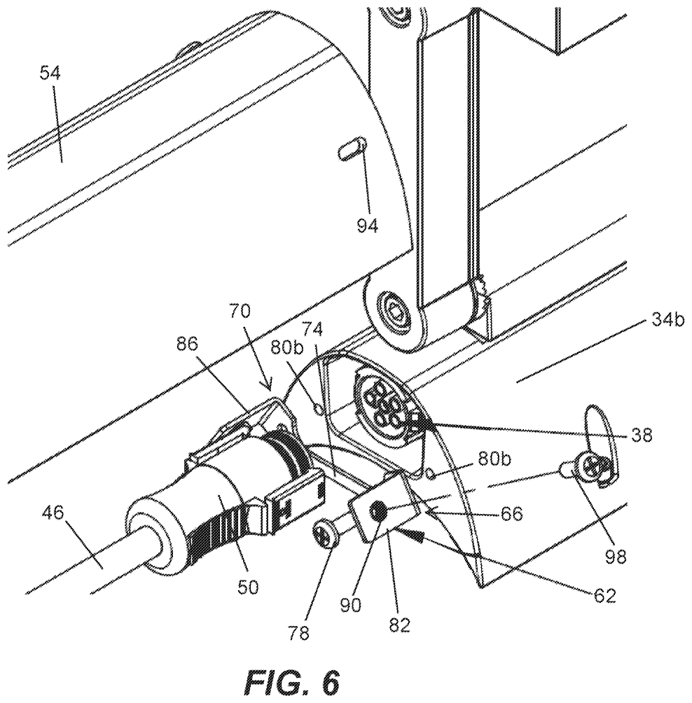

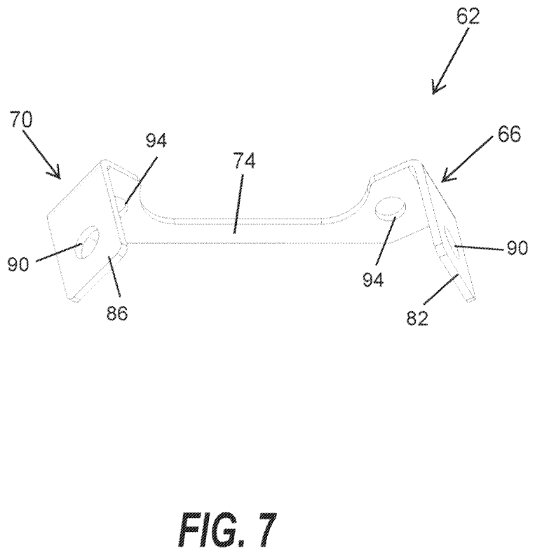

As shown in FIGS. 6 and 7, the cover 54 is coupled to the second light fixture IOb by a bracket 62. The bracket 62 includes a first portion 66, a second portion 70, and an intermediate portion 74 connected the first portion 66 and the second portion 70. Each of the first portion 66 and the second portion 70 is coupled to the housing 18b (e.g., by fasteners 78 (FIG. 6) extending through the first portion 66 and second portion 70 and engaging openings 80 in the support portion 34b of the housing 18b). In the illustrated embodiment, the fasteners 78 may engage the same holes in the housing 18b by which an associated end cover (FIG. 5) can be coupled to the support portion 34b when the bracket 62 is not in place. The first portion 66 and the second portion 70 are positioned on opposite sides of the connector 50.

The first portion 66 includes a first standoff or first flange 82 and the second portion 70 includes a second standoff or second flange 86, and the flanges 82, 86 are coupled to the cover 54. In the illustrated embodiment, each of the first flange 82 and the second flange 86 includes a hole 90, and the first portion 66 and second portion 70 each include a hole 94 through which the fasteners 78 may pass to engage the holes 80b. As shown in FIG. 6, when the cover 54 is positioned adjacent the housing 18, slots 94 positioned in the cover 54 are aligned with the holes 90. The portion of the cover 54 through which the slots 94 extend may be formed substantially planar in order to facilitate coupling with the flanges 82, 86. A fastener 98 is passed through an associated slot 94 and hole 90 to secure the cover 54 to the bracket 62. In some embodiments, the fastener 98 may engage a nut on an inner side of the flange; in other embodiments, the hole 90 itself may be threaded. It is understood that the cover 54 is coupled to the first light fixture 10a in a similar manner. Also, in other embodiments, the first portion and second portion of the bracket may be separate components. The light fixtures 10, 10a may be spaced apart by a predetermined distance that permits the cover 54 to be coupled to both brackets 62.

The embodiments described above and illustrated in the figures are presented by way of example only and are not intended as a limitation upon the concepts and principles presented herein. As such, it will be appreciated that variations and modifications exist within the scope and spirit of one or more independent aspects as described.

What is claimed is:

1. Alight fixture comprising:
a housing;
a light assembly comprising a plurality of light emitting diodes (LEDs) supported on an LED board, the LED board supported in the housing;
a plurality of optics, wherein each optic is positioned adjacent an associated LED of the LED board; and
a holder body supported within the housing, wherein the holder body comprises a plurality of recesses and each recess supports an optic.

2. The light fixture of claim 1, wherein the housing comprises a main portion and a support portion, and further comprising:
a support arm operably connected to the support portion of the housing and configured to support the light fixture on a surface.

3. The light fixture of claim 2, wherein the main portion comprises an opening through which light is emitted from the plurality of LEDs.

4. The light fixture of claim 1, wherein the plurality of optics comprises total internal reflection (TIR) optics, wherein each TIR optic comprises one end positioned adjacent an associated LED of the LED board and a second end through which light is output.

5. The light fixture of claim 1, wherein each recess comprises a shape which is substantially similar to the shape of the outer surface of an optic.

6. The light fixture of claim 5, wherein each recess has a substantially frustoconical shape.

7. The light fixture of claim 1, wherein the holder body comprises a retention feature adjacent each recess.

8. The light fixture of claim 7, wherein the retention feature comprises a snap fit feature, wherein each fit feature secures an associated optic.

9. The light fixture of claim 7, wherein each optic comprises a complementary feature for engaging the retention feature.

10. The light fixture of claim 9, wherein each complementary feature provides a snap fit feature between each recess and an associated optic.

11. A system of interconnected light fixtures, comprising:
a first light fixture including an elongated first housing and a first light emitting element, the first housing including a first end, a second end, and a first electrical connector;
a second light fixture including an elongated second housing and a second light emitting element, the second housing including a first end, a second end, and a second electrical connector;
a bracket configured for coupling to the first light fixture by a first fastener, wherein the bracket includes a first portion configured to be coupled to the first light fixture and a second portion configured to be coupled to the first light fixture;
an electrical cord providing electrical communication between the first light fixture and the second light fixture, the electrical cord including a third electrical connector removably coupled to the first electrical connector, and a fourth electrical connector removably coupled to the second electrical connector; and
a cover removably coupled to the first light fixture via the bracket by a second fastener and removably coupled to the second light fixture, the cover extending over the electrical cord, the cover including a first end adjacent the first light fixture, a second end adjacent the second light fixture, and a cover surface extending between the first end and the second end, a portion of the cover surface adjacent the first end having a profile that corresponds to a profile of a surface of the first light fixture, and a portion of the cover surface adjacent the second end having a profile that corresponds to a profile of a surface of the second light fixture, providing a continuous surface between the first light fixture and the second light fixture.

12. The system of interconnected light fixtures of claim 11, wherein the bracket is a first bracket, further comprising a second bracket coupled to the second light fixture, and wherein the cover is removably coupled to the second bracket via a third fastener.

13. The system of interconnected light fixtures of claim 11, wherein the first portion of the bracket includes a first flange oriented parallel to a first portion of the cover, and wherein the first flange comprises a hole for receiving a fastener extending through the first portion of the cover.

14. The system of interconnected light fixtures of claim 13, wherein the second portion of the bracket includes a second flange oriented parallel to a second portion of the cover, and wherein the second flange comprises a hole for receiving a fastener extending through the second portion of the cover.

15. The system of interconnected light fixtures of claim 11, wherein the first housing includes a first portion and a second portion, the first portion including an opening through which light from the first light emitting element passes, the second portion positioned on a side of the first portion opposite the opening, the second portion having a length less than a length of the first portion of the housing, the first electrical connector being positioned on the second portion of the housing.

16. The system of interconnected light fixtures of claim 15, wherein the first end of the cover is positioned adjacent a surface of the second portion.

17. The system of interconnected light fixtures of claim 15, wherein an end of the second portion proximate the cover is configured to be selectively coupled to an end plate.
